(19) United States
(12) Patent Application Publication
(10) Pub. No.: US 2007/0125846 A1
(43) Pub. Date: Jun. 7, 2007

(54) Kiosk for prepaid delivery package

(76) Inventors: Bill Hemingway, Bend, OR (US); Rene R. Lundy, Bend, OR (US)

Correspondence Address: PEDERSEN & COMPANY, PLLC, P.O. BOX 2666, BOISE, ID, 83701, US

(21) Appl. No.: 11/488,586

(22) Filed: Jul. 17, 2006

Related U.S. Application Data
(60) Provisional application No. 60/700,073, filed on Jul. 15, 2005.

(51) Int. Cl. G06F 7/08

(52) U.S. Cl. 235/381

(57) ABSTRACT

A kiosk for dispensing and mailing prepaid delivery envelopes. In the preferred embodiment, the kiosk dispenses a prepaid envelope upon receipt of payment from the customer. The customer fills out the envelope and deposits it back into the kiosk for delivery. The kiosk is self-contained and the envelopes are secured in the kiosk prior to vending, and also after deposit by the user. The kiosk requires no weighing device as the envelopes are prepaid and may be packed to capacity without any additional weight charges. Also, the kiosk preferably contains no other facilities for calculating or otherwise determining a delivery charge.

This application claims priority of Provisional Application Ser. No. 60/700,073, filed Jul. 15, 2005, and entitled “Kiosk For Prepaid Delivery Package With Drop Box”, which is herein incorporated by reference.

### BACKGROUND OF THE INVENTION

1. Field of the Invention

The present invention relates to a kiosk, and more particularly to a kiosk for dispensing prepaid delivery envelopes upon payment.

2. Related Art

References relating to delivery kiosks are listed as follows: Sansone, et al. (U.S. Pat. No. 5,457,636), Denman (U.S. Pat. No. 5,737,729), Sansone, et al. (U.S. Pat. No. 5,909,373), and Kranyec (U.S. Publication No. 2005/0108111).

### SUMMARY OF THE INVENTION

The present invention is an interactive kiosk for purchasing and dispensing a prepaid envelope. More particularly, the invention relates to a kiosk for purchasing and dispensing a prepaid envelope, such as a DHL prepaid envelope. Preferably the kiosk houses a microprocessor optionally connected to a video player display and a credit card machine. In one embodiment, the microprocessor incorporates graphics and software applications which cause the video player to display on a screen a series of digital graphics and/or text that attract and/or provide information to the user. In another embodiment, hard-copy graphics and/or text on the kiosk attract and provide information to the user. The kiosk further comprises a credit card reader machine linked to the microprocessor for receiving and processing a credit card for payment. The microprocessor is not configured to calculate a delivery fee or charge as the customer is charged a flat rate for each envelope. Alternatively, the kiosk may be configured to also receive debit cards or cash. The kiosk dispenses a single prepaid envelope upon payment using a small geared motor powering a roller device that picks up an envelope. There is no weighing system in the kiosk, nor any weighing step involved in this process. The customer simply fills-out the envelope label by filling in the delivery address, and optionally a return address, and fills the envelope full of content without being charged for the additional weight. After the user customer seals the envelope, and takes a receipt, preferably by peeling off a copy of the envelope label, the user may deposit the envelope in a drop box contained in or near the kiosk housing. The drop box, which is the slot, lid, door or other opening for receiving envelopes, is preferably freely openable to the customer, and allows the user to deposit an envelope into the housing, but prevents anyone from removing envelopes from within the housing. The kiosk vendor has access to the drop box, and/or to the space within the housing in which deposited envelopes accumulate, and preferably picks up the envelopes each day for delivery. The kiosk vendor may also have a device capable of reading the credit card batch information and sending that information to be processed for billing. Alternatively, the kiosk may be connected, wirelessly or by phone or other hard-wired transmission line, for transmitting the credit card information real-time, periodically, or upon demand, for processing.

### BRIEF DESCRIPTION OF THE DRAWINGS

FIG. 1 is a perspective view of one embodiment of the preferred kiosk.

FIG. 2 is a perspective view of a customer inserting a credit card into the credit card terminal on the kiosk depicted in FIG. 1.

FIG. 3 is a perspective view of the kiosk depicted in FIG. 1 dispensing the envelope and the customer receiving the envelope.

FIG. 4 is a perspective view of the customer filling out the address label already affixed to the envelope depicted in FIG. 3.

FIG. 5 is a perspective view of the customer removing the customer copy of the address label as a receipt.

FIG. 6 is a perspective view of the customer inserting materials to be sent into the envelope.

FIG. 7 is a perspective view of the customer depositing the envelope with its contents into the kiosk drop box.

FIG. 8 is a perspective view of the kiosk vendor or courier keying in a code in order to access the envelopes in the drop box.

FIG. 9 is a perspective view of the kiosk vendor or courier removing the envelopes from inside the kiosk housing for beginning the delivery process.

FIG. 10 is a perspective view of an alternate embodiment of the kiosk of the present invention with the separate, conventional drop box being nearby.

### DETAILED DESCRIPTION OF THE INVENTION

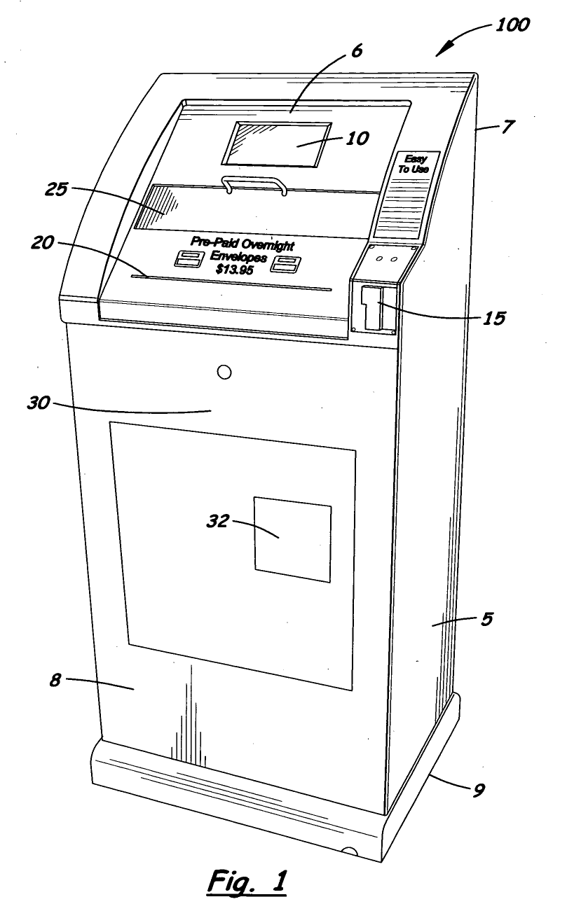

Referring to the Figures, there is shown several, but not the only, embodiments of the invented kiosk for dispensing prepaid delivery envelopes (optionally including cartons) upon payment. As shown in FIGS. 1-9, the preferred kiosk 100 comprises a housing 5. The inside of the housing 5 comprises a space (not shown) for storing envelopes 200, a space 27 for receiving envelopes ready for mailing, a microprocessor (not shown), and a video player (not shown). The outside of the housing 5 comprises a display screen 10, a credit card terminal 15, a dispensing slot 20, a drop box 25, and an access door 30. The preferred housing 10 may be built to look generally like the “Upright Newspaper Rack Dispenser” (U.S. Design Pat. No. D454,915) assigned to Bellatrix Systems, Inc. which is the company developing the presently disclosed invention. The kiosk 100 is an independent, stand alone, unattended unit that interacts with the customer via display screen and a series of prompts. The kiosk 100 may operate off battery power, or be powered by a wired electrical connection. Also, the kiosk 100 may be hard-wired, or wirelessly connected to information communication facilities, for example, for credit card approval, debit card debit, and/or for uploading or downloading of financial information automatically or when instructed by the vendor or financial service entity. Therefore, the credit card reader or terminal machine is, in effect, a transaction card reader. However it may also receive cash. Therefore, it may also be considered a payment device.

Additionally, the body of the kiosk 100 may be marked with hard-copy indicia such as a set of instructions, credit card symbols, pricing information, and the name of the company that owns the kiosk's (such as DHL or other companies that dispense prepaid envelopes), to aid the customer in operating the kiosk 100. The body of the kiosk 100 may also be painted in the colors of the company dispensing the envelopes to flag the customer as to what type of kiosk 100 it is; for example, if DHL owns the kiosk 100, the body of the kiosk may be painted yellow and red to help convey that information to the customer. The display screen 10, and dispensing slot 20, and drop box 25 are positioned on the top face 6 of the housing 5, and the top face 6 of the housing is slanted downward from the back face 7 to the front face 8 for convenience and easy viewing by the customer. However, the kiosk has no weighing system as the charge for delivery is fixed, and built into the fee for the prepaid package.

In the preferred embodiment, the display screen 10 is an LCD screen. The display screen 10 may have touch screen capabilities, however, due to the simple nature of this kiosk 100 this feature may not be necessary. A money acceptor, such as a conventional credit card terminal 15 may be fitted to the machine. The credit card terminal 15 is preferably linked to the microprocessor and can accept a variety of credit cards or debit cards. The credit card terminal 15, in one embodiment, automatically contacts, via a communication network, a credit card processing company that authorizes or declines payment from the credit card being used for a transaction; this process may be done optionally through a phone line, using wireless technology, or other transmission means. Optionally, the credit card information may be stored locally on kiosk 100 for batch reading, pick-up and later processing. The credit card reader may also be adapted to read level 3 information for customer tracking and customer audit functions. The credit card information is preferably double encrypted for security and will be transmitted as such or stored in the credit card terminal 15 until accessed by the vendor of the kiosk 100. For example, the payment information may be retrieved with a properly coded hand-held device, such as a Personal Digital Assistant (PDA), which may be configured to use infra-red to read the card terminal and transfer the data to the kiosk vendor. In addition to the credit card terminal 15, the kiosk 100 may also be manufactured to include an electronic bill and change acceptor. Further, the kiosk 100 may also include a receipt printer linked to the microprocessor. However, the microprocessor will not be configured to calculate a delivery fee or charge, as this is taken into account for the fixed fee of the prepaid package.

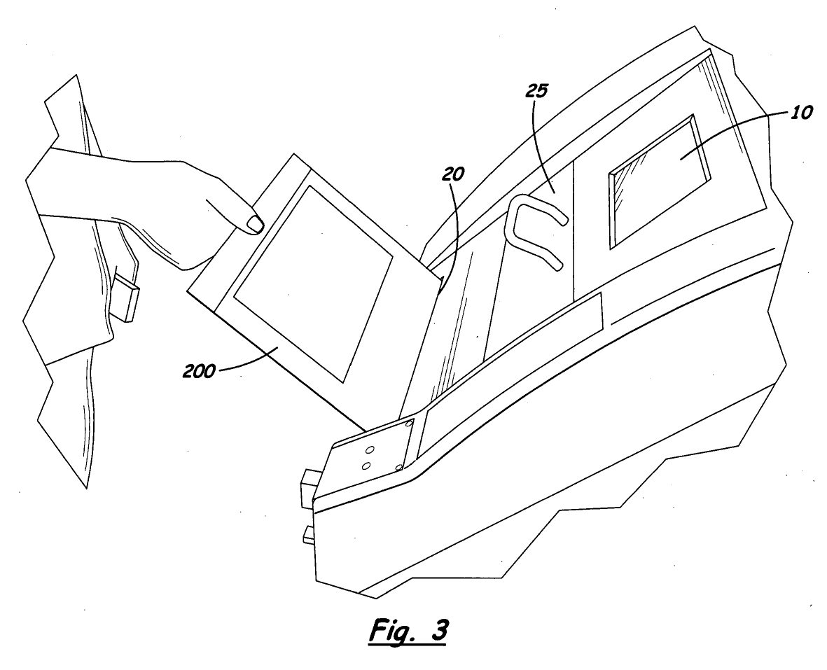

The dispensing slot 20 is preferably a generally elongated slot that extends across the top face 6 of the kiosk 100. The slot 20 is adapted to dispense an envelope 200 upon the customer swiping a credit card and the credit card being approved. Envelope 200 comes from an inventory of prepaid delivery packages stored within kiosk 100. The dispensing slot 20 is generally just slightly longer than the length of the envelope 200, in order to dispense the envelope 200 as shown in FIG. 3. Inside the kiosk 100 is preferably a unit utilizing a small geared motor powering a rubber roller device that picks up an envelope from the space where the envelopes 200 are stored for dispensing the envelopes 200 one at a time through the dispensing slot 20. Additionally, there is preferably a weighted hold-down that exerts the exact pressure to vend a single envelope no matter how high the stack is. In the preferred embodiment, approximately 50 envelopes can be loaded into the kiosk 100 for dispensing; the kiosk 100 may be modified to include fewer or more envelopes if necessary. The prepaid packages are marked for delivery at a fixed rate, and no additional charges are made for delivering the envelope.

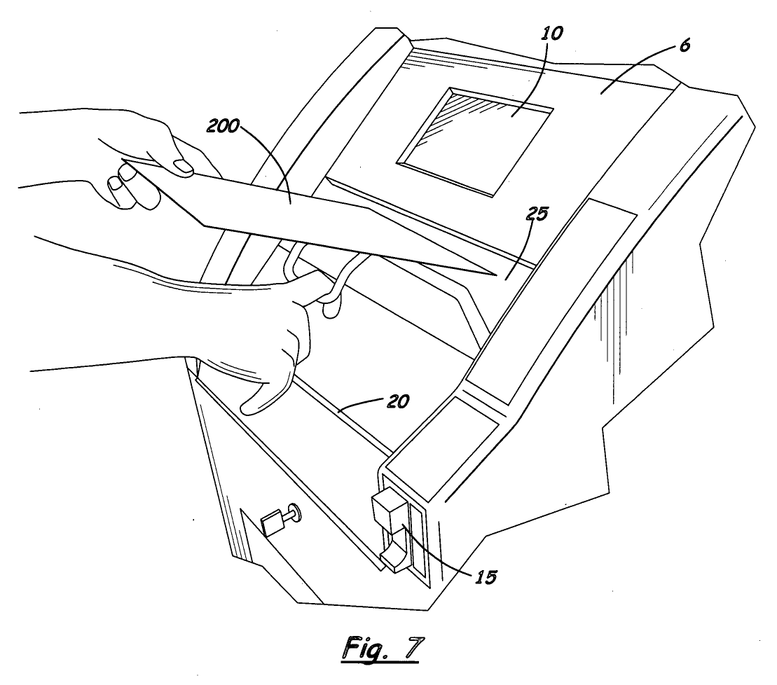

The drop box 25 is preferably fitted with an external handle to aid the customer in opening the drop box 25. The drop box 25 is designed to be hinged so that when the customer pulls down on the handle, the drop box 25 opens (see FIG. 7). The length of the drop box 25 is preferably the same length as the envelope 200 or slightly larger to make it easy to deposit the envelope 200 into the drop box 25. Alternatively, the drop box 25 may be sized to be generally the same width as the envelope. In the preferred embodiment, when the drop box 25 is opened, a shelf connected to the drop box 25 extends across the inside of the kiosk 100 generally from the front face 8 to the back face 7, so that the shelf is generally parallel to the base 9 of the kiosk 100. This shelf permits the customer to deposit the envelope 200 into the kiosk 100, but does not permit anyone to reach into the kiosk 100 through the drop box 25 and remove envelopes. When the customer releases the handle on the drop box 25, the shelf moves inside the kiosk 100 to be generally parallel to the front face 8 of the kiosk 100, and as it moves it “drops” the envelope into the receiving space 27 for the envelopes 200 inside the kiosk 100.

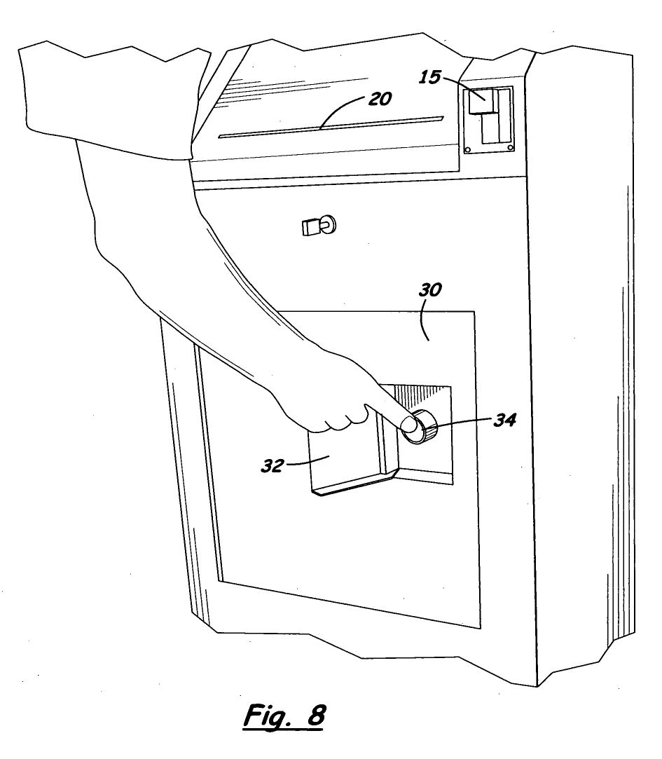

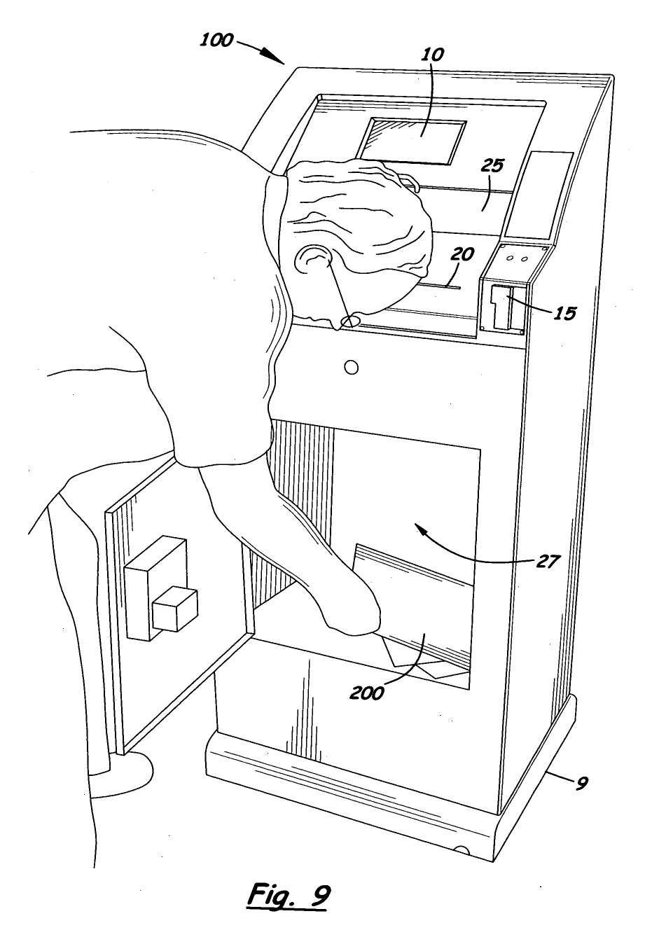

When the envelopes 200 need to be removed from receiving space 27 for delivery, or if the inside of the kiosk 100 needs to be accessed for repair, a courier, repairman, or other person with authorization to access from the kiosk vendor may open the lock 34 on the access door 30, which releases a latch on the access door 30 allowing the individual to access the inside of the kiosk 100 (see FIGS. 8 and 9). The lock 34 may be a keypad, a combination lock, a coded lock, a lock that is opened with a key, or other locking device that releases or locks the latching mechanism on the access door 30.

The process of using the interactive kiosk 100 for purchasing and mailing an envelope 200 is described hereinafter with reference to FIGS. 1-9. The microprocessor, in one embodiment, is configured to continuously run a promotional message on the display screen 10 with flashy graphics and a quick overview on how to use the kiosk 100. The message preferably has no sound, but uses a combination of sub-titles and graphics. Additionally, the promotional message periodically flashes a screen that tells the customer whether or not any prepaid envelopes 200 are still available for vending, and whether the envelopes 200 have already been picked up that day. The promotional message is on a continuous cycle between 5-10 seconds. The last screen on the promotional message asks the customer to insert their card or money for purchasing.

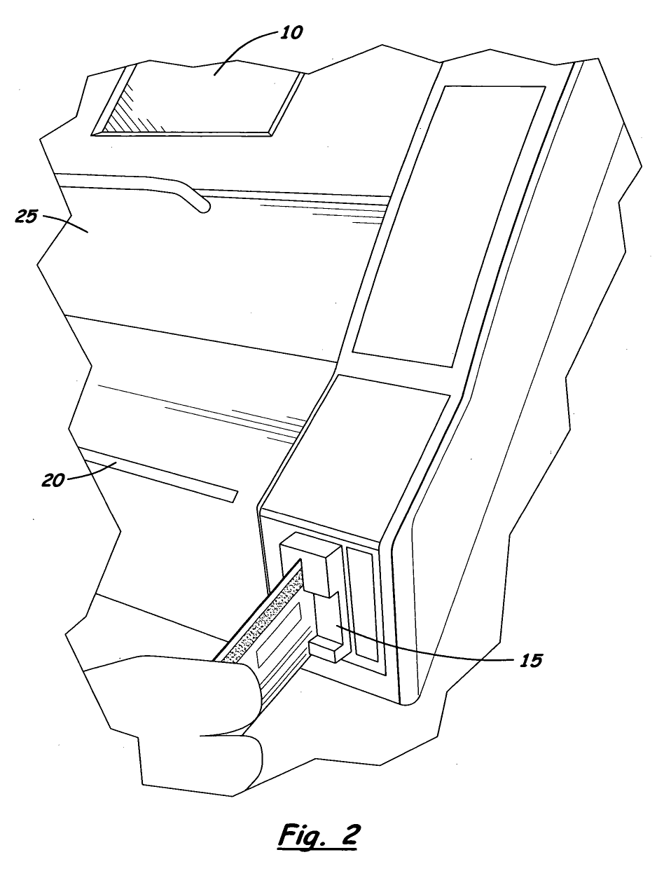

Once the customer has decided whether they will purchase an envelope 200, they insert their credit card or money in the credit card terminal 15 (see FIG. 2). The microprocessor reads the information on the card, and upon authorization of the credit card, the kiosk 100 starts a tutorial on the display screen 10, and dispenses a single envelope 200 through the dispensing slot 20 (FIG. 2). In the preferred embodiment, the kiosk 100 is designed to dispense DHL prepaid envelopes. Currently, DHL provides prepaid envelopes 200 that have an all inclusive flat-rate prepaid pricing, guaranteed delivery by 12:00 pm the next business day, free pick-up, no weight restrictions, and no expiration date in the lower 48 states. The flat-rate pricing is regardless of whether you ship across the state or across the country and the envelopes can be filled to capacity by the user without any additional weight charges. Because the envelopes are prepaid, there are no invoices to reconcile, no airbills to fill out and no account numbers to remember or enter. DHL, currently provides prepaid envelopes in three standard sizes: letter (12.5″×9.5″), legal (15″×9.5″), and express pack (16″×12″). In the preferred embodiment, the kiosk 100 is configured to dispense letter size envelopes 200. However, other sized envelopes may be dispensed upon the company's request. The envelopes 200 come already affixed with a shipping label, which has a built-in receipt for the user in the form of a “carbon copy” or other duplicate.

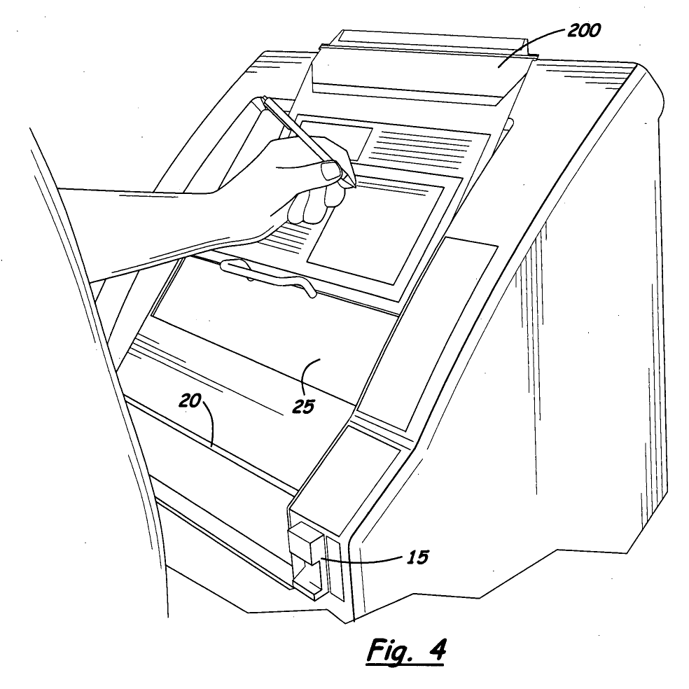

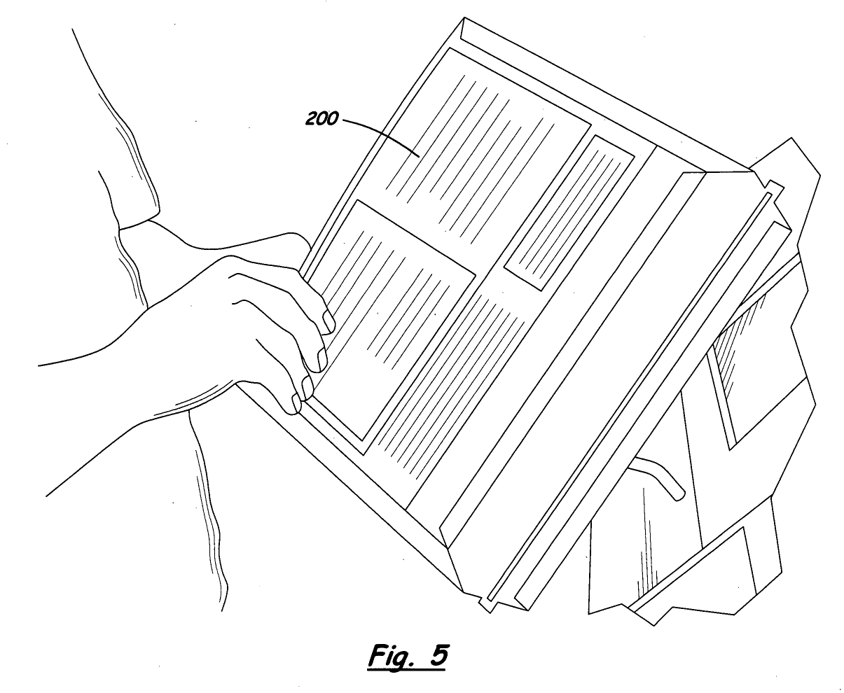

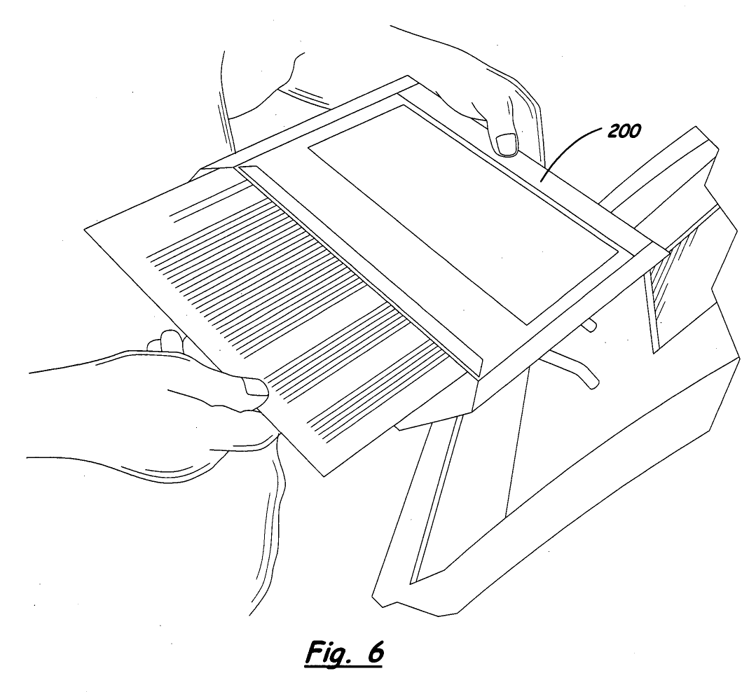

After an envelope 200 is dispensed out through the dispensing slot 20 in the kiosk 100, a tutorial appears on the display screen 10 which instructs the customer to “take the envelope”. The tutorial then tells the customer to fill out the “To” and “From” boxes on the shipping label and how to remove the sender's copy of the label for their records (see FIGS. 4 and 5). The shipping label contains the tracking and packaging information which acts also as the customer's receipt. The customer may rest the envelope on the handle on the drop box 25, and use the slanted top face 6 of the kiosk 100 housing 5 to write on. The tutorial then illustrates how to “fill” and “seal” the envelope 200 for mailing (see FIG. 6). Finally, the tutorial instructs the customer to place the sealed envelope 200 in the drop box 25 for shipping (see FIG. 7).

In the preferred embodiment, when the courier picks up the envelopes 200, they open the latch mechanism that keeps the access door 30 closed, by entering in a known combination into the lock 34. The preferred lock 34 is hidden from view via a cover 32 that is flush with the access door. The cover may be locked in order to further secure the lock mechanism. The kiosk 100 is preferably capable of being stationed anywhere without the need to be connected to an electrical power-line when configured to run off battery power, nor to a phone line, by using wireless or other transmission technology. In the preferred embodiment, the credit card information is accessed by an individual who is authorized to go around to the different kiosks 100, and, preferably, using a PDA with infrared capabilities, reads the credit card information through an infrared device positioned on or close to the credit card terminal 15. The individual then docks the PDA in a central processing unit in order to send the credit card information for processing.

The kiosk 100 is designed to be easy to use and requires very few steps in order to make it non-intimidating for the customer. The kiosk 100 does not require a scale or other weighing type station because the envelopes 200 are prepaid and permit the user to pack the envelopes to capacity without any additional weight charge. Further, the envelopes 200 are secured within the kiosk 100, so that people cannot steal the envelopes and it also reduces the temptation for vandalism. The preferred kiosk 100 with the digital display screen 10 will probably need to be connected to an electrical outlet; however, a similar kiosk with good instructional graphics and without a video could be configured to run on battery power. Maps or other prepaid items may be dispensed by the preferred kiosk 100. The kiosk 100 may also be used to deposit envelopes made and distributed by the company that owns the kiosk 100 even if the envelope was not purchased at the kiosk 100. For example, if a customer bought a DHL prepaid envelope online, or if they have an envelope to be billed to a current account, they may deposit that envelope at one of the kiosks 100 and it will be delivered.

In some embodiments the invented kiosk 100, may be described as consisting only of a single housing, a credit card terminal including a system for transmitting or storing the credit card information, a single envelope dispensing unit, a drop box system with space inside the kiosk housing for collecting deposited envelopes, an access door for accessing the space inside the kiosk housing, digital and/or printed operating instructions, wherein the above elements are all contained within or on the single housing, that is, without weighing/scale facilities, and without any facilities for calculating or otherwise determining a delivery charge. Also, preferably, the only supplies available at the kiosk are the internally-stored flat-rate envelopes that are dispensed one at a time upon each entry of a card or money, or, optionally, one at a time upon repeated instructions from the user to the kiosk to charge the same card.

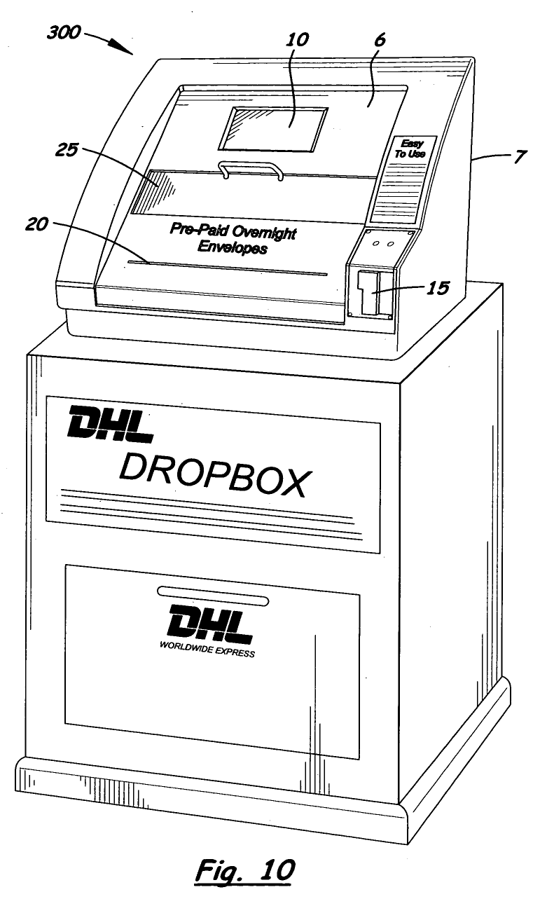

Referring to FIG. 10, there is depicted an alternate embodiment 300 of the present invention. Other items called out in FIG. 10 are the same as items called out in FIGS. 1-9. In this embodiment, the interactive kiosk does not include a drop box for the vended, prepaid envelope. Instead, the kiosk in this embodiment is placed conveniently near the drop box, for example, of a conventional non-prepaid envelope dispenser. This way, the structural requirements of the kiosk are reduced, in that the already-present drop box of a conventional dispenser is not required. Instead, the drop box of the nearby conventional unit is conveniently also used as the drop box for this alternative embodiment of the invention.

Although this invention has been described above with reference to particular means, materials and embodiments, it is to be understood that the invention is not limited to these disclosed particulars, but extends instead to all equivalents within the scope of the following claims.

I claim:

1. A kiosk for vending a prepaid delivery package, comprising:
a transaction card reader;
an inventory of prepaid delivery packages;
a dispenser for dispensing a prepaid delivery package from said inventory and upon command via said transaction card reader; and,
the kiosk being without a weighing system.

2. A kiosk for vending a prepaid delivery package, comprising:
a payment input device;
an inventory of prepaid delivery packages;
a dispenser for dispensing a prepaid delivery package from said inventory and upon command via said transaction card reader;
the kiosk being without a weighing system.

3. A kiosk for vending a prepaid delivery package, comprising:
a payment input device;
a microprocessor operably connected to said payment input device;
a dispenser for dispensing a prepaid delivery package from said inventory upon command from said microprocessor, and,
the microprocessor not being configured to calculate a delivery fee or charge.
